(19) United States
(12) Patent Application Publication
(10) Pub. No.: US 2023/0189038 A1
(43) Pub. Date: Jun. 15, 2023

(54) ACQUISITION AND REPORTING OF CHANNEL MEASUREMENTS AND INTERFERENCE MEASUREMENTS

(71) Applicant: Telefonaktiebolaget LM Ericsson (publ), Stockholm (SE)

(72) Inventors: Mattias FRENNE, UPPSALA (SE); Sebastian FAXÉR, STOCKHOLM (SE); Andreas NILSSON, GÖTEBORG (SE)

(73) Assignee: Telefonaktiebolaget LM Ericsson (publ), Stockholm (SE)

(21) Appl. No.: 17/924,552

(22) PCT Filed: May 13, 2020
(86) PCT No.: PCT/EP2020/063327

§ 371 Date: Nov. 10, 2022

(51) Int. Cl. H04W 24/10; H04L 5/00; H04B 17/309; H04B 7/06

(52) U.S. Cl. CPC H04W 24/10; H04L 5/0051; H04B 17/309; H04B 7/0695; H04B 7/0632

(57) ABSTRACT

There is provided mechanisms for channel measurement and interference measurement acquisition. A method is performed by a network node. The method comprises configuring a terminal device to perform and report channel measurements for a first reference signal resource set and interference measurements for a second reference signal resource set. The method comprises transmitting the first reference signal resource set and the second reference signal resource set. The method comprises receiving reporting of the channel measurements and the interference measurements, from the terminal device. The interference measurements are reported as a function of measurement on at least two reference signal resources in the second reference signal resource set.

### TECHNICAL FIELD

Embodiments presented herein relate to a method, a network node, a computer program, and a computer program product for channel measurement and interference measurement acquisition. Embodiments presented herein further relate to a method, a terminal device, a computer program, and a computer program product for channel measurement and interference measurement reporting.

### BACKGROUND

In communications networks, there may be a challenge to obtain good performance and capacity for a given communications protocol, its parameters and the physical environment in which the communications network is deployed.

For example, for future generations of mobile communications networks, frequency bands at many different carrier frequencies could be needed. For example, low such frequency bands could be needed to achieve sufficient network coverage for wireless devices and higher frequency bands (e.g. at millimeter wavelengths (mmW), i.e. near and above 30 GHz) could be needed to reach required network capacity. In general terms, at high frequencies the propagation properties of the radio channel are more challenging and beamforming both at the network node of the network and at the wireless devices might be required to reach a sufficient link budget.

Narrow beam transmission and reception schemes might be needed at such high frequencies to compensate the expected high propagation loss. For a given communication link, a respective beam can be applied at both the network-end (as represented by a network node or its transmission and reception point, TRP) and at the terminal-end (as represented by a terminal device), which typically is referred to as a beam pair link (BPL). A BPL (i.e. both the beam used by the network node and the beam used by the terminal device) is expected to be discovered and monitored by the network using measurements on downlink reference signals, such as channel state information reference signals (CSI-RS) or synchronization signal block (SSB) signals, used for beam management.

One purpose of MU-MIMO is to serve multiple terminal devices simultaneously in the same time, frequency, and code resource and in this way increase the capacity of the communication network. If the network node has multiple antenna panels it can perform MU-MIMO transmission by, e.g., transmitting to one terminal device from each antenna panel. To achieve significant capacity gains with MU-MIMO, low interference between co-scheduled terminal devices should be ensured. This can be achieved by making accurate CSI available at the network node to facilitate interference nulling in the precoding (mainly applicable for digital antenna arrays), and/or by co-scheduling terminal devices that have close to orthogonal channels. An example of the latter is if two terminal devices are in line-of-sight and have an angular separation larger than the beamwidth of an antenna panel. In this case, the two terminal devices can be co-scheduled by the network node transmitting with a beam directed to the first terminal device from one antenna panel and transmitting with a beam directed to the second terminal device from another antenna panel.

To enable MU-MIMO for a network node having analog antenna panels, the network node should determine a beam for transmission to each respective terminal device which keeps the inter-device interference low whilst maintaining a strong signal for each terminal device, and in this way attaining high signal plus interference and noise ratio (SINR) for all co-scheduled terminal devices. A beam management procedure can be used for discovery and maintenance of BPLs. In some aspects, the beam management procedure is defined in terms of a P-1 sub-procedure, a P-2 sub-procedure, and a P-3 sub-procedure.

The CSI-RS for beam management can be transmitted periodically, semi-persistently or aperiodically (event triggered) and they can be either shared between multiple terminal devices or be device-specific. The SSB are transmitted periodically and are shared for all terminal devices. In order for the terminal device to find a suitable network node beam, the network node, during the P-1 sub-procedure, transmits the reference signal in different transmission (TX) beams on which the terminal device performs measurements, such as reference signal received power (RSRP), and reports back the N best TX beams (where N can be configured by the network). Furthermore, the transmission of the reference signal on a given TX beam can be repeated to allow the terminal device to evaluate a suitable reception (RX) beam. Reference signals that are shared between all terminal devices served by the TRP might be used to determine a first coarse direction for the terminal devices. It could be suitable for such a periodic TX beam sweep at the TRP to use SSB as the reference signal. One reason for this is that SSB are anyway transmitted periodically (for initial access/synchronization purposes) and SSBs are also expected to be beamformed at higher frequencies to overcome the higher propagation losses noted above.

A finer beam sweep in more narrow beams than used during the P-1 sub-procedure might then be performed at the network node during a P-2 sub-procedure to determine a more detailed direction for each terminal device. Here, the CSI-RS might be used as reference signal. As for the P-1 sub-procedure, the terminal device performs measurements, such as reference signal received power (RSRP), and reports back the N best TX beams (where N can be configured by the network).

Furthermore, the CSI-RS transmission in the transmission beam selected during the P-2 sub-procedure can be repeated in a P-3 sub-procedure to allow the terminal device to evaluate suitable RX beams at the terminal device.

However, the beam management procedure does not necessarily provide information about how, or even if, the terminal devices could be co-scheduled.

Hence, there is still a need for improved mechanisms for determining whether or not two or more terminal devices could be co-scheduled.

### SUMMARY

An object of embodiments herein is to provide efficient signalling that enables determination of whether or not two or more terminal devices could be co-scheduled.

According to a first aspect there is presented a method for channel measurement and interference measurement acquisition. The method is performed by a network node. The method comprises configuring a terminal device to perform and report channel measurements for a first reference signal resource set and interference measurements for a second reference signal resource set. The method comprises transmitting the first reference signal resource set and the second reference signal resource set. The method comprises receiving reporting of the channel measurements and the interference measurements, from the terminal device. The interference measurements are reported as a function of measurement on at least two reference signal resources in the second reference signal resource set.

According to a second aspect there is presented a network node for channel measurement and interference measurement acquisition. The network node comprises processing circuitry. The processing circuitry is configured to cause the network node to configure a terminal device to perform and report channel measurements for a first reference signal resource set and interference measurements for a second reference signal resource set. The processing circuitry is configured to cause the network node to transmit the first reference signal resource set and the second reference signal resource set. The processing circuitry is configured to cause the network node to receive reporting of the channel measurements and the interference measurements, from the terminal device. The interference measurements are reported as a function of measurement on at least two reference signal resources in the second reference signal resource set.

According to a third aspect there is presented a network node for channel measurement and interference measurement acquisition. The network node comprises a configure module configured to configure a terminal device to perform and report channel measurements for a first reference signal resource set and interference measurements for a second reference signal resource set. The network node comprises a transmit module configured to transmit the first reference signal resource set and the second reference signal resource set. The network node comprises a receive module configured to receive reporting of the channel measurements and the interference measurements, from the terminal device. The interference measurements are reported as a function of measurement on at least two reference signal resources in the second reference signal resource set.

According to a fourth aspect there is presented a computer program for channel measurement and interference measurement acquisition. The computer program comprises computer program code which, when run on processing circuitry of a network node, causes the network node to perform a method according to the first aspect.

According to a fifth aspect there is presented a method for channel measurement and interference measurement reporting. The method is performed by a terminal device. The method comprises receiving configuration from a network node to perform and report channel measurements for a first reference signal resource set and interference measurements for a second reference signal resource set. The method comprises receiving the first reference signal resource set and the second reference signal resource set whilst performing channel measurements on the first reference signal resource set and performing interference measurements on the second reference signal resource set. The method comprises providing reporting of the channel measurements and the interference measurements to the network node. The interference measurements are reported as a function of measurements on at least two reference signal resources in the second reference signal resource set.

According to a sixth aspect there is presented a terminal device for channel measurement and interference measurement reporting. The terminal device comprises processing circuitry. The processing circuitry is configured to cause the terminal device to receive configuration from a network node to perform and report channel measurements for a first reference signal resource set and interference measurements for a second reference signal resource set. The processing circuitry is configured to cause the terminal device to receive the first reference signal resource set and the second reference signal resource set whilst performing channel measurements on the first reference signal resource set and performing interference measurements on the second reference signal resource set. The processing circuitry is configured to cause the terminal device to provide reporting of the channel measurements and the interference measurements to the network node. The interference measurements are reported as a function of measurements on at least two reference signal resources in the second reference signal resource set.

According to a seventh aspect there is presented a terminal device for channel measurement and interference measurement reporting. The terminal device comprises a receive module configured to receive configuration from a network node to perform and report channel measurements for a first reference signal resource set and interference measurements for a second reference signal resource set. The terminal device comprises a receive module configured to receive the first reference signal resource set and the second reference signal resource set whilst performing channel measurements on the first reference signal resource set and performing interference measurements on the second reference signal resource set. The terminal device comprises a provide module configured to provide reporting of the channel measurements and the interference measurements to the network node. The interference measurements are reported as a function of measurements on at least two reference signal resources in the second reference signal resource set.

According to an eighth aspect there is presented a computer program for channel measurement and interference measurement reporting, the computer program comprising computer program code which, when run on processing circuitry of a terminal device, causes the terminal device to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient signalling that enables determination by the network node of whether or not the terminal device could be co-scheduled with another terminal device (on at least partly overlapping time/frequency resources).

Advantageously, these aspects enable the channel measurement and interference measurement acquisition and reporting to be performed with a comparatively small signaling overhead.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 schematically illustrates the antenna architecture of a terminal device according to an embodiment;

FIG. 3 schematically illustrates a beam management procedure according to embodiments;

FIG. 4 is a schematic diagram illustrating part of the communication network in FIG. 1 according to embodiments;

FIGS. 5 and 7 are flowcharts of methods according to embodiments;

FIG. 6 is a schematic illustration of a network node, a TRP, and terminal devices according to embodiments;

FIG. 8 is a schematic diagram showing functional units of a network node according to an embodiment;

FIG. 9 is a schematic diagram showing functional modules of a network node according to an embodiment;

FIG. 10 is a schematic diagram showing functional units of a terminal device according to an embodiment;

FIG. 11 is a schematic diagram showing functional modules of a terminal device according to an embodiment; and

FIG. 12 shows one example of a computer program product comprising computer readable storage medium according to an embodiment;

FIG. 13 is a schematic diagram illustrating a telecommunication network connected via an intermediate network to a host computer in accordance with some embodiments; and

FIG. 14 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

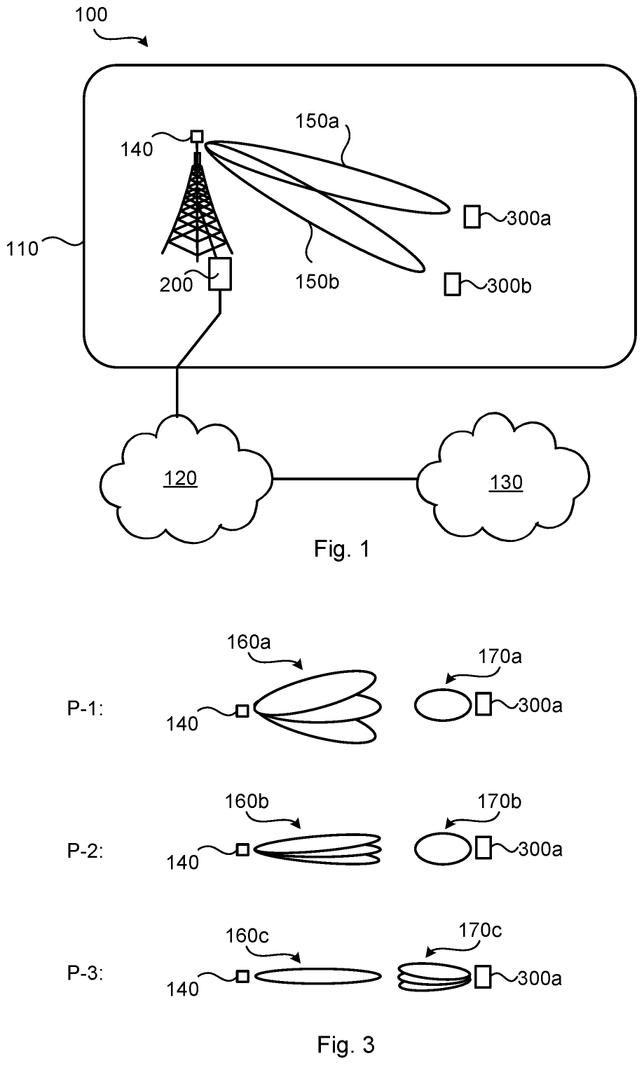

FIG. 1 is a schematic diagram illustrating a communication network 100 where embodiments presented herein can be applied. The communication network 100 could be a third generation (3G) telecommunications network, a fourth generation (4G) telecommunications network, a fifth generation (5G) telecommunications network, or any evolvement thereof, and support any 3GPP telecommunications standard, where applicable.

The communication network 100 comprises a network node 200 configured to provide network access to terminal devices, as represented by terminal devices 300a, 300b, in a radio access network 110. The radio access network 110 is operatively connected to a core network 120. The core network 120 is in turn operatively connected to a service network 130, such as the Internet. The terminal devices 300a, 300b are thereby enabled to, via the network node 200, access services of, and exchange data with, the service network 130.

The network node 200 comprises, is collocated with, is integrated with, or is in operational communications with, a transmission and reception point (TRP) 140. The network node 200 (via its TRP 140) and the terminal devices 300a, 300b is configured to communicate with each other in beams, two of which are illustrated at reference numerals 150a, 150b. In this respect, beams that could be used both as TX beams and RX beams will hereinafter simply be referred to as beams.

Examples of network nodes 200 are radio access network nodes, radio base stations, base transceiver stations, Node Bs, evolved Node Bs, g NBs, access points, access nodes, and backhaul nodes. Examples of terminal devices 300a, 300b are wireless devices, mobile stations, mobile phones, handsets, wireless local loop phones, user equipment (UE), smartphones, laptop computers, tablet computers, network equipped sensors, network equipped vehicles, and so-called Internet of Things devices.

There could be different types of antenna arrangements that the terminal devices 300a, 300b are provided with in order for the terminal devices 300a, 300b to efficiently communicate with the TRP 140. In this respect, an antenna panel might be defined as a rectangular antenna array of dual-polarized antenna elements with typically one transmit/receive unit (TXRU) per polarization. An analog distribution network with phase shifters can be used to steer a directional beam as generated at each such antenna panel. Alternatively, the terminal devices 300a, 300b are configured for digital wideband (time domain beamformed) beamforming that mimics the operation and function of the analog distribution network. Multiple antenna panels might be stacked next to each other and digital beamforming can be performed across the antenna panels. For the terminal devices 300a, 300b, depending on its physical orientation, signals might arrive and emanate from all different directions. Hence, it might be beneficial to have an antenna implementation at the terminal devices 300a, 300b which is enabled to generate omni-directional-like coverage for the terminal devices 300a, 300b in addition to high gain narrow directional beams. One way to increase the omni-directional coverage at the terminal devices 300a, 300b is to provide the terminal devices 300a, 300b with multiple antenna panels, where at least two of the antenna panels have different pointing directions.

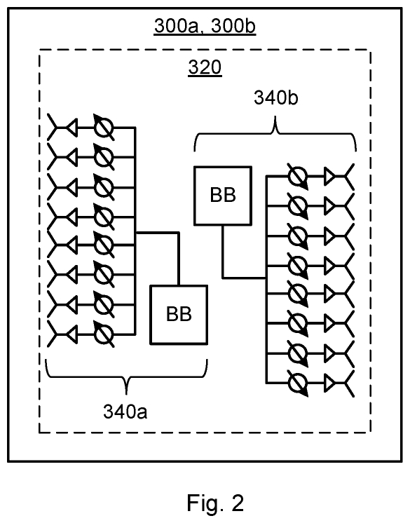

FIG. 2 schematically illustrates an example antenna architecture of the terminal devices 300a, 300b. According to the illustrated antenna architecture, the terminal devices 300a, 300b is equipped with two antenna arrays 340a, 340b. Each antenna array 340a, 340b has dual-polarized antenna elements. In the illustrated example, each antenna array 340a, 340b has eight single-polarized or dual-polarized antenna elements but as the skilled person understands, each antenna array 340a, 340b might have less than eight dual-polarized antenna elements or more than eight dual-polarized antenna elements. Each antenna array 340a, 340b is connectable to a receiver chain, or baseband chain (BB) in the terminal device 300a, 300b. The antenna architecture might be part of a communications interface 320 of the terminal devices 300a, 300b. Thus, in some embodiments, the terminal device 300a, 300b is equipped with antenna arrays 340a, 340b having dual-polarized antenna elements, where the antenna arrays 340a, 340b are connected to receiver chains in the terminal device 300a, 300b.

As noted above, there is still a need for improved mechanisms for determining whether or not two or more terminal devices 300a, 300b could be co-scheduled (on at least partly overlapping time/frequency resources).

FIG. 3 schematically illustrates a beam management procedure consisting of three sub-procedures, referred to as P-1, P-2, and P-3 sub-procedures. These three sub-procedures will now be disclosed in more detail. For simplicity, only one terminal device 300a is illustrated in FIG. 3 but the skilled person understands that the beam management procedure could also be performed for two or more terminal devices 300a, 300b.

One main purpose of the P-1 sub-procedure is for the network node 200 to find a coarse direction towards the terminal device 300a by transmitting reference signals in wide, but narrower than sector, beams that are swept over the whole angular sector. The TRP 140 is expected to, for the P-1 sub-procedure, utilize beams, according to a spatial beam pattern 160a, with rather large beam widths. During the P-1 sub-procedure, the reference signals are typically transmitted periodically and are shared between all terminal devices 300a, 300b served by the network node 200 in the radio access network 110. The terminal devices 300a, 300b typically use a wide, or even omni-directional beam for receiving the reference signals during the P-1 sub-procedure, according to a spatial beam pattern 170a. The reference signals might be periodically transmitted CSI-RS (or, formally, CSI-RS resources) or SSB. The terminal device 300a might then to the network node 200 report the N 1 best beams and their corresponding quality values, such as reference signal received power (RSRP) values. The beam reporting from the terminal device 300a to the network node 200 might be performed rather seldom (in order to save overhead) and can be either periodic, semi-persistent or aperiodic.

One main purpose of the P-2 sub-procedure is to refine the beam selection at the TRP 140 by the network node 200 transmitting reference signals whilst performing a new beam sweep with more narrow directional beams, according to a spatial beam pattern 160b, than those beams used during the P-1 sub-procedure, where the new beam sweep is performed around the coarse direction, or beam, reported during the P-1 sub-procedure. During the P-2 sub-procedure, the terminal devices 300a, 300b typically use the same beam as during the P-1 sub-procedure, according to a spatial beam pattern 170b. The terminal devices 300a, 300b might then to the network node 200 report the N 1 best beams and their corresponding quality values, such as reference signal received power (RSRP) values. One P-2 sub-procedure might be performed per each terminal device 300a, 300b or per each group of terminal devices 300a, 300b. The reference signals might be aperiodically or semi-persistently transmitted CSI-RS (or, formally, CSI-RS resources). The P-2 sub-procedure might be performed more frequently than the P-1 sub-procedure in order to track movements of the terminal devices 300a, 300b and/or changes in the radio propagation environment.

One main purpose of the P-3 sub-procedure is for terminal devices 300a, 300b utilizing analog beamforming, or digital wideband (time domain beamformed) beamforming, to find best beam. During the P-3 sub-procedure, the reference signals are transmitted, according to a spatial beam pattern 160c, in the best reported beam of the P-2 sub-procedure whilst the terminal devices 300a, 300b performs a beam sweep, according to a spatial beam pattern 170c. The P-3 sub-procedure might be performed at least as frequently as the P-2 sub-procedure in order to enable the terminal device 300a, 300b to compensate for blocking, and/or rotation.

Whereas the above beam management procedure could be used to find suitable beams for both the network node 200 (or its TRP 140) and the terminal devices 300a, 300b, the beam management procedure does not necessarily provide information about how, or even if, the terminal devices 300a, 300b could be co-scheduled.

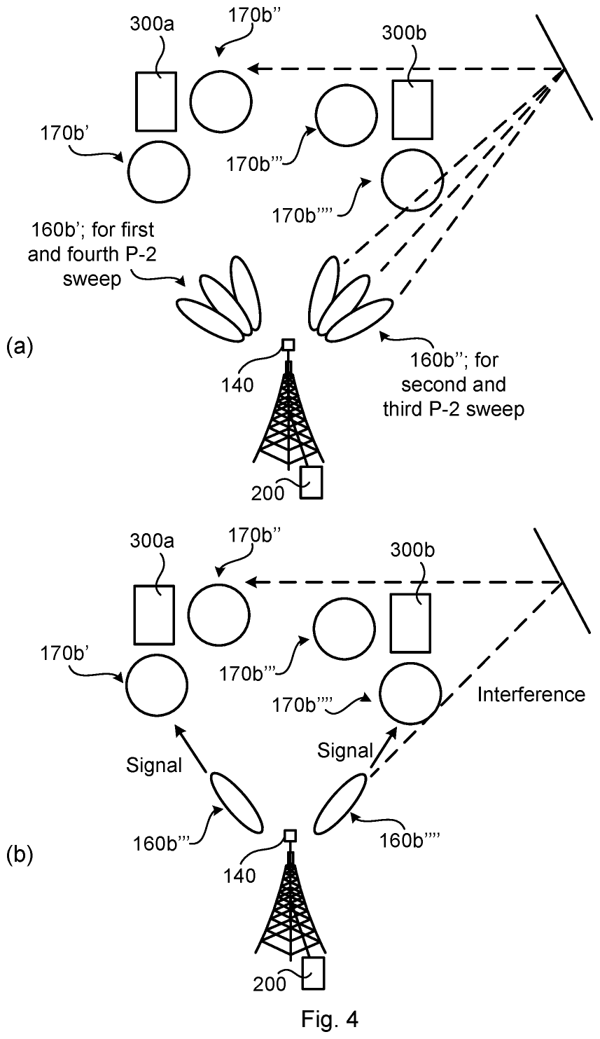

One issue is how to find good co-scheduling candidates for MU-MIMO co-scheduling in a scattering environment and where the terminal devices 300a, 300b are provided with two or more antenna panels. FIG. 4(a) schematically illustrates part of the communication network 100 where a first P-2 beam sweep, according to a spatial beam pattern 160b′, is performed for terminal device 300a and a second P-2 beam sweep, according to a spatial beam pattern 160b″, is performed for terminal device 300b. A third P-2 beam sweep might be performed for terminal device 300a also according to the spatial beam pattern 160b″ and a fourth beam sweep might be performed for terminal device 300b also according to the spatial beam pattern 160b′. Then, the first and second P-2 beam sweeps could be used for the network node 200 to acquire channel measurements for the terminal devices 300a, 300b whereas the third and fourth P-2 beam sweeps could be used for the network node to acquire interference measurements for the terminal devices 300a, 300b. The terminal devices 300a, 300b are necessarily not informed of the purpose of the measurements.

Terminal device 300a is provided with two antenna panels that are utilized during the P-2 beam sweeps, where a first of the two antenna panels gives rise to spatial beam pattern 170b′, and a second of the two antenna panels gives rise to spatial beam pattern 170b″. Terminal device 300b is provided with two antenna panels that are utilized during the P-2 beam sweeps, where a first of the two antenna panels gives rise to spatial beam pattern 170b′″, and a second of the two antenna panels gives rise to spatial beam pattern 170b″″. According to the illustrative example of FIG. 4(a), the reference signals in the third P-2 beam sweep will, due to reflection, be received by terminal device 300a in the spatial beam pattern 170b”. Terminal device 300a will thus receive strong signals in all beams used during the third P-2 beam sweep, according to the spatial beam pattern 160b″, and will hence report strong RSRP for all these beams. The network node 200 will interpret this as if terminal device 300a would suffer from interference if any of the beams in the spatial beam pattern 160b″ is used for data and/or control signaling towards terminal device 300b. The network node 200 will therefore assume that MU-MIMO co-scheduling for terminal device 300a and terminal device 300b is not possible.

However, as can be seen from FIG. 4(b), which shows the same scenario as in FIG. 4(a), it would indeed be possible to co-schedule the two terminal devices 300a, 300b for MU-MIMO since the best beam 160b′″ from the first P-2 beam sweep will be received mainly with spatial beam pattern 170b′ at terminal device 300a, whilst the interference from the best beam 160b″″ for terminal device 300b from the second P-2 beam sweep (which is also reported as a strong RSRP for the third P-2 beam sweep by terminal device 300a) will be received mainly with spatial beam pattern 170b″ at terminal device 300a. Since the signal and interference thus is received at mainly different antenna panels at terminal device 300a, it would be possible to co-schedule terminal device 300a and terminal device 300b with MU-MIMO, even though current beam management procedures would not give any such indications.

The embodiments disclosed herein therefore relate to mechanisms for channel measurement and interference measurement acquisition and channel measurement and interference measurement reporting. Such mechanisms could be beneficial when determining whether or not two or more terminal devices 300a, 300b could be co-scheduled (on at least partly overlapping time/frequency resources), such as in a MU-MIMO system.

In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a terminal device 300a, a method performed by the terminal device 300a, and a computer program product comprising code, for example in the form of a computer program, that when run on processing circuitry of the terminal device 300a, causes the terminal device 300a to perform the method.

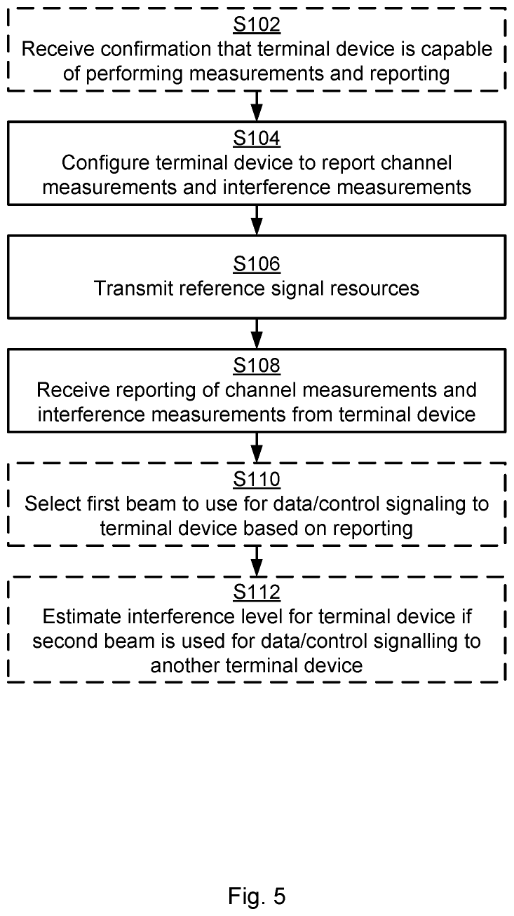

Reference is now made to FIG. 5 illustrating a method for channel measurement and interference measurement acquisition as performed by the network node 200 according to an embodiment.

S104: The network node 200 configures the terminal device 300a to perform and report channel measurements for a first reference signal resource set and interference measurements for a second reference signal resource set.

S106: The network node 200 transmits the first reference signal resource set and the second reference signal resource set.

S108: The network node 200 receives reporting of the channel measurements and the interference measurements from the terminal device 300a. The interference measurements are reported as a function of measurement on at least two reference signal resources in the second reference signal resource set. The channel measurements and the interference measurements are received in one and the same reporting.

Using the received reporting, the network node 200 can determine how reliable the average interference level would be when selecting a transmission beam for communication with the terminal device 300a, where the selected transmission beam corresponds to one of the reference signal resources of the first reference signal resource set.

Embodiments relating to further details of channel measurement and interference measurement acquisition as performed by the network node 200 will now be disclosed.

As will be further disclosed below, the reference signal resources might be device-specific. The network node 200 might thus configure each served terminal device 300a, 300b with its own reference signal resources. The reference signal resources for channel measurements and the reference signal resources for interference measurements might hence be specific for the terminal device 300a. There could be different ways for the network node 200 to determine which reference signal resources the terminal device 300a is to use for channel measurements and which reference signal resources the terminal device 300a is to use for interference measurements. In some embodiments, for which of the first reference signal resource set and the second reference signal resource set the terminal device 300a is to report channel measurements and for which of the first reference signal resource set and the second reference signal resource set the terminal device 300a is to report interference measurements is based on reporting received from the terminal device 300a of a beam sweep performed by the network node 200. The beam sweep might involve the network node 200 to transmit reference signal resources, such as SSB, in a set of beams. This set of beams typically consists of beams that are wider (i.e., have larger beam widths) than those beams that are used for data and/or control signalling to the terminal devices 300a, 300b.

The reference signal resources used for channel measurements by the terminal device 300a might be used for interference measurements by another terminal device 300b, and the reference signal resources used for interference measurements by the terminal device 300a might be used for channel measurements by this another terminal device 300b.

As disclosed above, the channel measurements and the interference measurements are received in one and the same reporting. Further in this respect, there might be different ways for the reporting of the channel measurements and the interference measurements to be provided. In some aspects, the reporting is provided by means of a link quality metric. That is, in some embodiments, the channel measurements and the interference measurements are reported as a combined link quality metric. Non-limiting examples of the link quality metric are CQI, SINR, and RSRP.

As disclosed above, the network node 200 configures the terminal device 300a to perform channel measurements. There could be different ways in which the network node 200 configures the terminal device 300a, for example in terms of the level of detail in which the network node 200 configures the terminal device 300a.

In this respect, in some embodiments, the terminal device 300a is configured by the network node 200 to report the interference measurements as a function of measurements on at least two reference signal resources in the second reference signal resource set. As an example, the terminal device 300a could be configured to report CSI-RS Resource Indicator (CRI) and RSRP from the first reference signal resource set and an interference level from the second reference signal resource set, where the interference level by the terminal device 300a is obtained by using a function of measurements on two or more of the reference signal resources in the second reference signal resource set. In some embodiments, each of the channel measurements and the interference measurements are represented by, or accompanied by, CRI and RSRP values determined for the first reference signal resource set and the second reference signal resource set. In some examples only the channel measurements are represented by, or accompanied by, CRI and/or RSRP values, where the CRI and/or RSRP values are determined for the first reference signal resource set (but not the second reference signal resource set). The terminal device 300a might, for example, report the interference together with N CRIs with strongest RSRP, and their corresponding RSRP values. In further aspects, the reporting might indicate how the interference differs among different reference signal resources in the second reference signal resource set. Further details relating thereto will be disclosed below.

In further aspects, the network node 200 might configure the terminal device 300a with respect to which spatial receiver filter the terminal device 300a is to receive the first reference signal resource set and the second reference signal resource set. In particular, in some embodiments, the terminal device 300a is configured by the network node 200 to receive the first reference signal resource set and the second reference signal resource set using one and the same spatial receiver filter as during reception of data and/or control signalling, for example during PDSCH signalling and/or PDCCH signalling. In further detail, since the terminal device 300a could report one interference level for all reference signal resources in the second reference signal resource set, the terminal device 300a should apply one fixed spatial receiver filter for all received reference signal resources; both for the reference signal resources used for the channel measurements and for the reference signal resources used for the interference measurements. Otherwise, for example if different receiver spatial filters are used for different reference signal resources used for channel measurements, the average interference level for the reference signal resources belonging to the second reference signal resource set might be different depending on which reference signal resource from the first reference signal resource set that is currently used.

In some aspects, the terminal device 300a confirms it capability to the network node 200, i.e., that the terminal device 300a is capable of performing and reporting measurements according to the configuration. In particular, in some embodiments, the network node 200 is configured to perform (optional) step S102:

S102: The network node 200 receives confirmation from the terminal device 300a that the terminal device 300a is capable of performing measurements and reporting the measurements as configured by the network node 200.

In some aspects, the reference signal resource sets are transmitted in beams; such as in one set of beams for the first reference signal resource set and another set of beams for the second reference signal resource set. In particular, in some embodiments, the first reference signal resource set is transmitted in a first set of beams, where each reference signal resource in the first reference signal resource set is transmitted in its own beam in the first set of beams.

One of the beams in the first set of beams might then be selected for further communication with the terminal device 300a. In particular, in some embodiments, the network node 200 is configured to perform (optional) step S110:

S110: The network node 200 selects, based on the reporting of the channel measurements, one of the beams in the first set of beams for data and/or control signalling to the terminal device 300a.

There could be different ways in which the beam in the first set of beams is selected. In some aspects the beam is selected as the beam for which the channel measurements have their highest value. In some aspects, the beam is selected also based on possible interference reported from another terminal device 300b. That is, in some embodiments, which beam in the first set of beams is selected further is based on reporting received from another terminal device 300b of interference measurements performed by this another terminal device 300b on the reference signal resources in the first reference signal resource set.

As noted above, also the second reference signal resource set might be transmitted in beams. In particular, in some embodiments, the second reference signal resource set is transmitted in a second set of beams, where each reference signal resource in the second reference signal resource set is transmitted in its own beam in the second set of beams.

In some aspects, each terminal device 300a, 300b is configured with its own sets of reference signal resources. The aforementioned first reference signal resource set and second reference signal resource set might thus be specific for terminal device 300a. The network node 200 might therefore transmits further reference signal resources for other terminal devices, such as terminal device 300b, for these terminal devices to perform measurements on and report; such as a third reference signal resource set for channel measurements and a fourth reference signal resource set for interference measurements for terminal device 300b. In this respect, the reference signal resource set for channel measurements for terminal device 300b might be transmitted in the same beams, or at least similar beams, as the reference signal resource set for interference measurements for terminal device 300a, and vice versa. The network node 200 might thereby estimate the interference caused to terminal device 300a if any of the beams in the second set of beams is selected to be used for data and/or control signalling to this another terminal device 300b. In particular, in some embodiments, the network node 200 is configured to perform (optional) step S112:

S112: The network node 200 estimates, based on the reporting of the interference measurements, interference level for the terminal device 300a if any beam in the second set of beams is used for data and/or control signalling to another terminal device 300b.

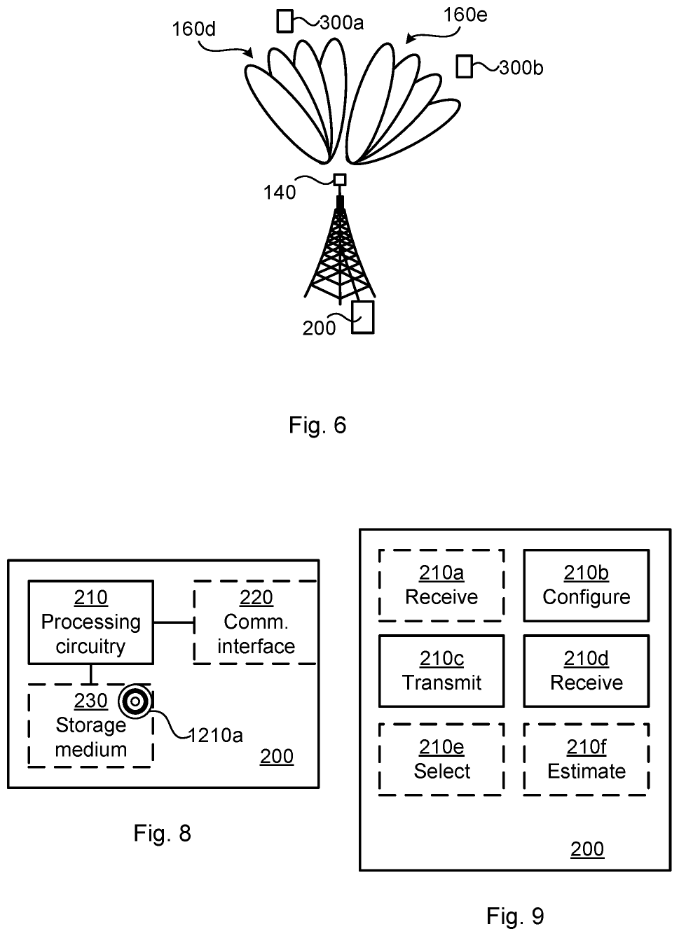

FIG. 6 schematically illustrates a network node 200 operatively connected to a TRP 140. A first reference signal resource set and a fourth reference signal resource set might be transmitted in beams defined by a spatial beam pattern 160d. The first reference signal resource set is used for channel measurements by terminal device 300a whereas the fourth reference signal resource set is used for interference measurements by terminal device 300b. A second reference signal resource set and a third reference signal resource set might be transmitted in beams defined by a spatial beam pattern 160e. The second reference signal resource set is used for interference measurements by terminal device 300a whereas the third reference signal resource set is used for channel measurements by terminal device 300b. It is here noted that this is just an example and the beams for terminal device 300a on the one hand and the beams for terminal device 300b on the other hand might differ.

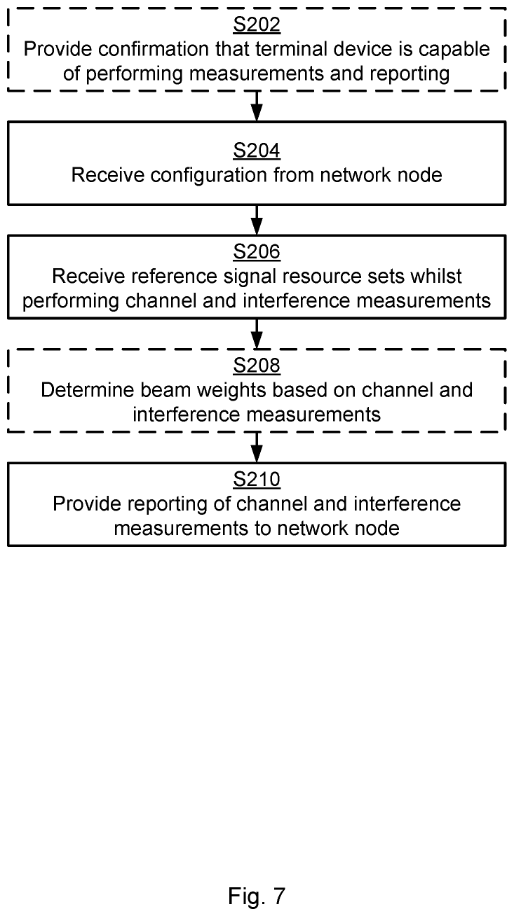

Reference is now made to FIG. 7 illustrating a method for channel measurement and interference measurement reporting as performed by the terminal device 300a according to an embodiment.

S204: The terminal device 300a receives configuration from the network node 200 to perform and report channel measurements for a first reference signal resource set and interference measurements for a second reference signal resource set.

S206: The terminal device 300a receives the first reference signal resource set and the second reference signal resource set whilst performing channel measurements on the first reference signal resource set and performing interference measurements on the second reference signal resource set.

S210: The terminal device 300a provides reporting of the channel measurements and the interference measurements to the network node 200. The interference measurements are reported as a function of measurements on at least two reference signal resources in the second reference signal resource set. The channel measurements and the interference measurements are provided in one and the same reporting.

Embodiments relating to further details of channel measurement and interference measurement reporting as performed by the terminal device 300a will now be disclosed.

As disclosed above, there might be different ways for the reporting of the channel measurements and the interference measurements to be provided. In some aspects, the reporting is provided by means of a link quality metric. That is, in some embodiments, the channel measurements and the interference measurements are reported as a combined link quality metric.

As disclosed above, there could be different ways in which the network node 200 configures the terminal device 300a, for example in terms of the level of detail in which the network node 200 configures the terminal device 300a. In this respect, in some embodiments, the terminal device 300a is configured by the network node 200 to report the interference measurements as a function of measurements on at least two reference signal resources in the second reference signal resource set.

In some aspects, the terminal device 300a confirms it capability to the network node 200, i.e., that the terminal device 300a is capable of performing and reporting measurements according to the configuration. In particular, in some embodiments, the terminal device 300a is configured to perform (optional) step S202:

S202: The terminal device 300a provides confirmation to the network node 200 that the terminal device 300a is capable of performing measurements and reporting the measurements as configured by the network node 200.

As in step S206, the terminal device 300a performs channel measurements on the first reference signal resource set and performs interference measurements on the second reference signal resource set. In this respect, the terminal device 300a might calculates, per receiver chain, one RSRP value per each reference signal resource in the first reference signal resource set. Further in this respect, the terminal device 300a might further calculate, per receiver chain, one average RSRP value for all reference signal resources belonging to the first reference signal resource set. That is, in some embodiments, one channel measurement for the first reference signal resource set is determined per receiver chain in the terminal device 300a. Further in this respect, the terminal device 300a might, per receiver chain calculate one interference value, where the interference value per receiver chain is the average RSRP calculated over all reference signal resources in the second reference signal resource set received by that receiver chain. That is, in some embodiments, one interference measurement for the second reference signal resource set is, per each receiver chain in the terminal device 300a, reported as a function of measurements, per receiver chain, on at least two reference signal resources in the second reference signal resource set.

As disclosed above, the network node 200 might configure the terminal device 300a with respect to which spatial receiver filter the terminal device 300a is to receive the first reference signal resource set and the second reference signal resource set. In particular, in some embodiments, the terminal device 300a is configured by the network node 200 to receive the first reference signal resource set and the second reference signal resource set using one and the same spatial receiver filter as during reception of data and/or control signalling. In this respect, the spatial receiver filter might be a digital filter defined by weight values that are set to increase SINR over multiple receiver chains. The weight values could be determined as if the terminal device 300a is receiving data, with the optimization goal to maximize, for example, the SINR.

As disclosed above, the reporting might be represented, or accompanied, by CRI and RSRP values. That is, in some embodiments, each of the channel measurements and the interference measurements are represented by, or accompanied by, CRI and RSRP values determined for the first reference signal resource set and the second reference signal resource set. As further disclosed above, in some examples only the channel measurements are represented by, or accompanied by, CRI and/or RSRP values, where the CRI and/or RSRP values are determined for the first reference signal resource set (but not the second reference signal resource set).

In some aspects, the terminal device 300a is to use one or more beams when receiving data and/or control signalling from the network node 200. The terminal device 300a might therefore determine beam weights for this one and more beams. In particular, in some embodiments, the terminal device 300a is configured to perform (optional) step S208:

S208: The terminal device 300a determines beam weights based on the channel measurements and the interference measurements.

In some aspects, one set of beam weights is determined for each receiver chain. That is, in some embodiments, one set of the beam weights is determined for each receiver chain in the terminal device 300a.

There could be different ways in which the terminal device 300a determines the beam weights based on the channel measurements and the interference measurements. In some examples, the beam weights are determined based on the average RSRP per receiver chain for the first reference signal resource set and the average interference per receiver chain for the second reference signal resource set.

The beam weights might thus be determined based on both the reference signal resources for channel measurements and the reference signal resources for interference measurements. However, the beam weights might be determined based on one spatial QCL assumption used for the channel measurements. Hence, in some aspects, the beam weights are based only on the channel measurements (such as based on the spatial QCL indication associated with the reference signal resources for the channel measurements).

In some aspects, determining the beam weights involves the terminal device 300a to determine which antenna panel to use for receiving data and/or control signalling from the network node 200 and/or which beam to apply on that panel(s). That is, the beam weights for one of the receiver chains could be set to zero. This implies that the receiver chain for which worst SIR is experienced might be switched off. In some examples the receiver chain for which worst SIR is experienced is switched off only during beam management and not during actual MU-MIMO transmissions from the network node 200 (i.e., including transmission of data and/or control signalling from the network node 200 to another terminal device 300b).

In some aspects, the terminal device 300a calculates the RSRP for each reference signal resource in the first reference signal resource set, where the terminal device 300a uses the determined beam weights. Further, the terminal device 300a might calculate an interference measure using two or more of the reference signal resources in the second reference signal resource set, where the terminal device 300a uses the determined beam weights. The channel measurements and the interference measurements might thus be reported as if the determined beam weights would have been applied. That is, in some embodiments, the channel measurements and the interference measurements are reported as if the beam weights were applied when the first reference signal resource set and the second reference signal resource set were received.

As disclosed above, the interference measurements are reported as a function of measurements on at least two reference signal resources in the second reference signal resource set. There could be different such functions. In some aspects, the interference measurements are reported as the linear average of the power, in Watt, of the interference. That is, in some embodiments, the reported interference measurements are determined as a linear average in power of measurements on the at least two reference signal resources in the second reference signal resource set. When computing the linear average of the power, the average can be defined as the linear average of the power contributions, in Watt, of the resource elements of the antenna ports that carry CSI reference signal resources configured for RSRP measurements within the considered measurement frequency bandwidth in the configured reference signal resource occasions.

Although it might be sufficient to report the interference measurements as a function of measurements on only two reference signal resources in the second reference signal resource set, it could be that the interference measurements are reported as a function of all reference signal resources in the second reference signal resource set. That is, in some embodiments, the interference measurements are reported as a function of measurements on all reference signal resources in the second reference signal resource set.

As disclosed above, the reporting might indicate how the interference differs among different reference signal resources in the second reference signal resource set. The terminal device 300a might thus in the reporting indicate a measure or variable that informs the network node 200 how the interference differs between different reference signal resources in the reference signal resource set used for interference measurements. Further details relating thereto will be disclosed next.

In some aspects, the terminal device 300a reports at least one of the following indicators.

According to a first example, the indicator is defined by an estimated variance of the interference of the reference signal resources, where the variance can be defined as the variance of the power contributions measured in Watt of the resource elements of the antenna ports that carry the reference signal resources configured for RSRP measurements within the considered measurement frequency bandwidth in the configured reference signal resource occasions used for interference measurement. Hence, in some embodiments, how the interference differs among different reference signal resources in the second reference signal resource set is indicated by the reporting comprising a variance value of the interference measurements.

According to a second example, the indicator is defined by the interference level of the reference signal resource with highest interference. Hence, in some embodiments, how the interference differs among different reference signal resources in the second reference signal resource set is indicated by the reporting comprising a value of highest interference measurement for the second reference signal resource set.

According to a third example, the indicator is defined by a flag that indicates that the variance in interference is above a certain level, where the level may be fixed according to a specification or configured to the terminal device 300a by the network node 200 using higher layer signaling. Hence, in some embodiments, how the interference differs among different reference signal resources in the second reference signal resource set is indicated by the reporting comprising a flag that is set only when a variance value of the interference measurements is above a predetermined threshold level.

According to a fourth example, the indicator is defined by a measure of the span of the RSRP, that is the difference between the measured RSRP of the NZP CSI-RS resources used for interference measurement, where the difference is obtained between the resource with highest and lowest measured RSRP. Hence, in some embodiments, how the interference differs among different reference signal resources in the second reference signal resource set is indicated by the reporting comprising a difference value determined as difference between highest measured interference for the second reference signal resource set and lowest measured interference for the second reference signal resource set.

According to a fifth example, the indicator is defined by an estimated median value of the interference of the reference signal resources, where the median can be defined as the median of the power contributions measured in Watt of the resource elements of the antenna ports that carry CSI reference signal resources configured for RSRP measurements within the considered measurement frequency bandwidth in the configured reference signal resource occasions used for interference measurement.

In some aspects, the reporting defines a transmission hypothesis indication. In particular, in some embodiments, the reporting of the channel measurements and the interference measurements defines a transmission hypothesis indication. The preferred transmission hypothesis indication might comprise an indication of at least one channel measurement resource and one interference measurement level, where the channel measurement resource is based on reference signal resources from a first reference signal resource set and where the interference measurement level is calculated as a function of at least two reference signal resources from a second reference signal resource set.

Each reference signal resource might be defined as one or several reference signals transmitted from one or several antenna ports. There could be different types of reference signals and reference signal resources. In some embodiments, each reference signal resource in the first reference signal resource set and in the second reference signal resource set is a non-zero power (NZP) reference signal resource. The reference signals might be channel state information reference signals (CSI-RS) and thus the reference signal resources might be CSI-RS resources, where each CSI-RS resource might consist of one or several CSI-RS ports. The reference signal resources might thus be NZP CSI-RS resources. Further, the reference signal resources (both for channel measurements and interference measurements) might be configured in a CSI-RS resource set with the parameter “repetition” set to either ‘off’ or ‘on (i.e. not used or used for beam management), as defined in document 3GPP TS 38.331 “NR; Radio Resource Control (RRC); Protocol specification”, V16.0.0. In further aspects, release 15 (Rel 15) and release 16 (Rel 16) of the 3GPP standardization of the new radio (NR) air interface, a CSI-RS resource configured for beam management (i.e., with the repetition parameter set to ‘off’ or ‘on’ in the NZP-CSI-RS-ResourceSet information element (as defined in aforementioned 3GPP TS 38.331 V16.0.0) can consist of up to two such CSI-RS ports.

FIG. 8 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1210a (as in FIG. 12), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, functions, nodes, and devices of the communication network 100 as well as entities, functions, nodes, and devices operatively connected to, or served, by, the communication network 100. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 9 schematically illustrates, in terms of a number of functional modules, the components of a network node 200 according to an embodiment. The network node 200 of FIG. 9 comprises a number of functional modules; a configure module 210b configured to perform step S104, a transmit module 210c configured to perform step S106, and a receive module 210d configured to perform step S108. The network node 200 of FIG. 9 may further comprise a number of optional functional modules, such as any of a receive module 210a configured to perform step S102, a select module 210e configured to perform step S110, and an estimate module 210f configured to perform step S112. In general terms, each functional module 210a-210f may be implemented in hardware or in software. Preferably, one or more or all functional modules 210a-210f may be implemented by the processing circuitry 210, possibly in cooperation with the communications interface 220 and/or the storage medium 230. The processing circuitry 210 may thus be arranged to from the storage medium 230 fetch instructions as provided by a functional module 210a-210f and to execute these instructions, thereby performing any steps of the network node 200 as disclosed herein.

The network node 200 may be provided as a standalone device or as a part of at least one further device. For example, the network node 200 may be provided in a node of the radio access network 110 or in a node of the core network 120. Alternatively, functionality of the network node 200 may be distributed between at least two devices, or nodes. These at least two nodes, or devices, may either be part of the same network part (such as the radio access network 110 or the core network 120) or may be spread between at least two such network parts. In general terms, instructions that are required to be performed in real time may be performed in a device, or node, operatively closer to the cell than instructions that are not required to be performed in real time. In this respect, at least part of the network node 200 may reside in the radio access network, such as in the radio access network node, for cases when embodiments as disclosed herein are performed in real time.

Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 8 the processing circuitry 210 may be distributed among a plurality of devices, or nodes. The same applies to the functional modules 210a-210f of FIG. 9 and the computer program 1220a of FIG. 12.

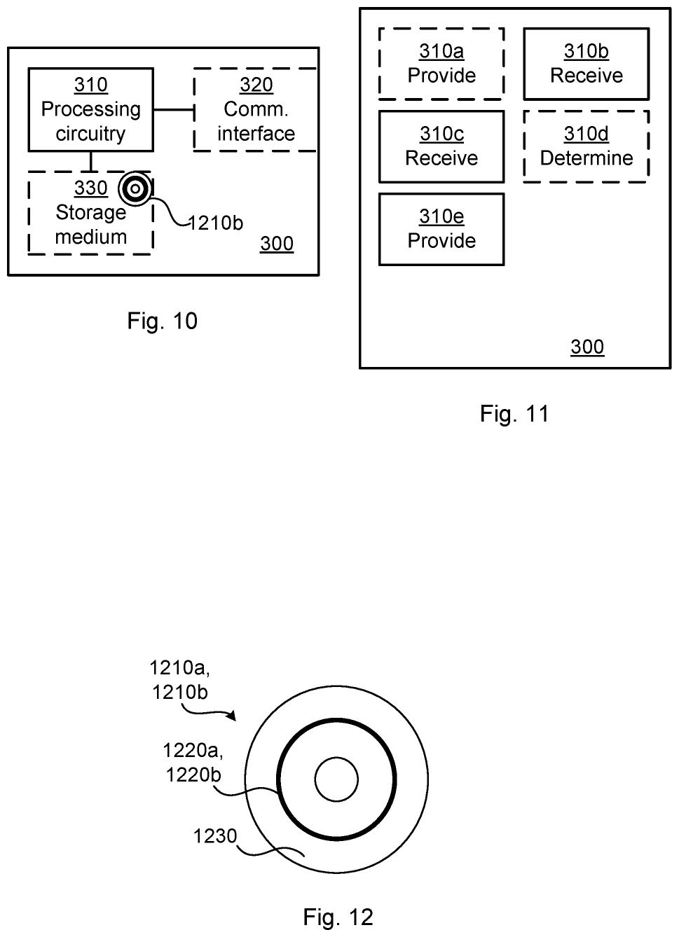

FIG. 10 schematically illustrates, in terms of a number of functional units, the components of a terminal device 300a, 300b according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1210b (as in FIG. 12), e.g. in the form of a storage medium 330. The processing circuitry 310 may further be provided as at least one application specific integrated circuit (ASIC), or field programmable gate array (FPGA).

Particularly, the processing circuitry 310 is configured to cause the terminal device 300a, 300b to perform a set of operations, or steps, as disclosed above. For example, the storage medium 330 may store the set of operations, and the processing circuitry 310 may be configured to retrieve the set of operations from the storage medium 330 to cause the terminal device 300a, 300b to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The terminal device 300a, 300b may further comprise a communications interface 320 for communications at least with the network node 200 via the TRP 140. As such the communications interface 320 may comprise one or more transmitters and receivers, comprising analogue and digital components.

The processing circuitry 310 controls the general operation of the terminal device 300a, 300b e.g. by sending data and control signals to the communications interface 320 and the storage medium 330, by receiving data and reports from the communications interface 320, and by retrieving data and instructions from the storage medium 330. Other components, as well as the related functionality, of the terminal device 300a, 300b are omitted in order not to obscure the concepts presented herein.

FIG. 11 schematically illustrates, in terms of a number of functional modules, the components of a terminal device 300a, 300b according to an embodiment. The terminal device 300a, 300b of FIG. 11 comprises a number of functional modules; a receive module 310b configured to perform step S204, a receive module 310c configured to perform step S206, and a provide module 310e configured to perform step S210. The terminal device 300a, 300b of FIG. 11 may further comprise a number of optional functional modules, such as any of a provide module 310a configured to perform step S202, and a determine module 310d configured to perform step S208. In general terms, each functional module 310a-310e may be implemented in hardware or in software. Preferably, one or more or all functional modules 310a-310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a-310e and to execute these instructions, thereby performing any steps of the terminal device 300a, 300b as disclosed herein.

FIG. 12 shows one example of a computer program product 1210a, 1210b comprising computer readable means 1230. On this computer readable means 1230, a computer program 1220a can be stored, which computer program 1220a can cause the processing circuitry 210 and thereto operatively coupled entities and devices, such as the communications interface 220 and the storage medium 230, to execute methods according to embodiments described herein. The computer program 1220a and/or computer program product 1210a may thus provide means for performing any steps of the network node 200 as herein disclosed. On this computer readable means 1230, a computer program 1220b can be stored, which computer program 1220b can cause the processing circuitry 310 and thereto operatively coupled entities and devices, such as the communications interface 320 and the storage medium 330, to execute methods according to embodiments described herein. The computer program 1220b and/or computer program product 1210b may thus provide means for performing any steps of the terminal device 300a as herein disclosed.

In the example of FIG. 12, the computer program product 1210a, 1210b is illustrated as an optical disc, such as a CD (compact disc) or a DVD (digital versatile disc) or a Blu-Ray disc. The computer program product 1210a, 1210b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1220a, 1220b is here schematically shown as a track on the depicted optical disk, the computer program 1220a, 1220b can be stored in any way which is suitable for the computer program product 1210a, 1210b.

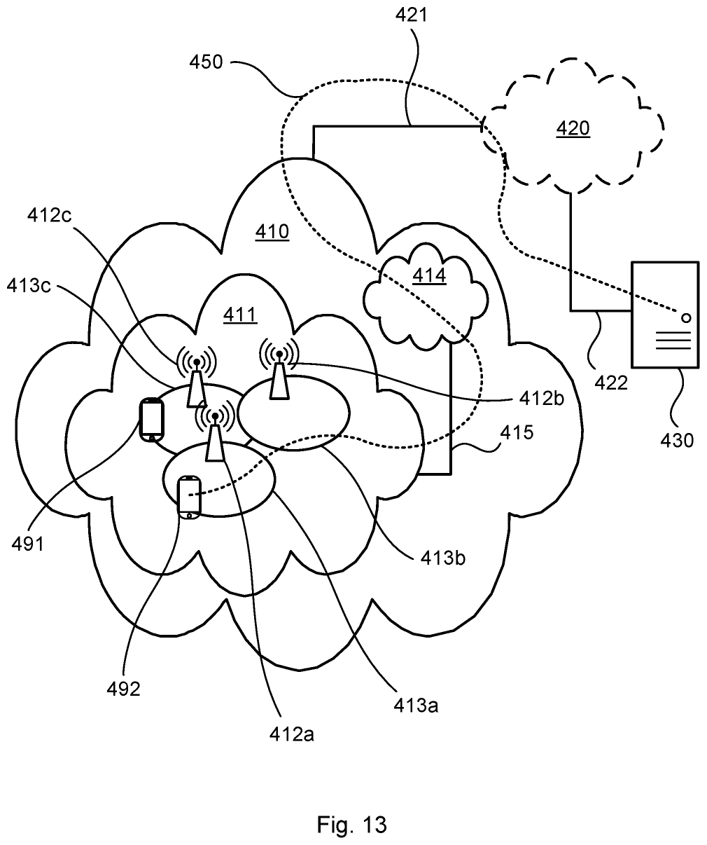

FIG. 13 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 200 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the terminal devices 300a, 300b of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 13 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

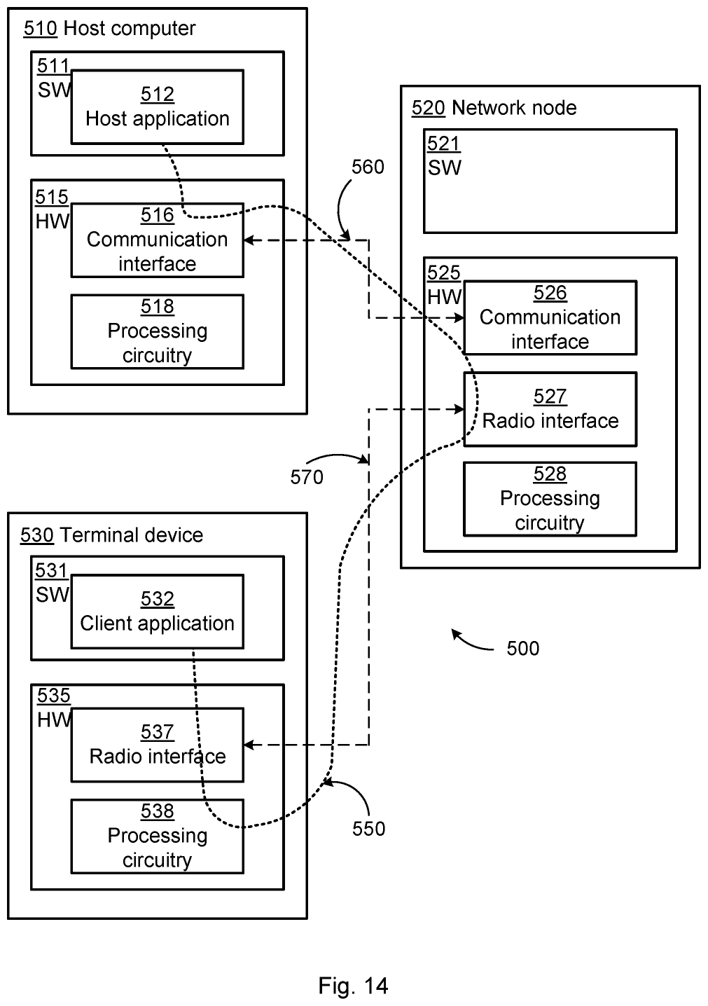

FIG. 14 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 14. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the terminal devices 300a, 300b of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 200 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 14) served by radio access network node 520. Communication interface 526 may be configured to facilitate connection 560 to host computer 510. Connection 560 may be direct or it may pass through a core network (not shown in FIG. 14) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 14 may be similar or identical to host computer 430, one of network nodes 412a, 412b, 412c and one of UEs 491, 492 of FIG. 13, respectively. This is to say, the inner workings of these entities may be as shown in FIG. 14 and independently, the surrounding network topology may be that of FIG. 13.

In FIG. 14, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signaling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for channel measurement and interference measurement acquisition, the method being performed by a network node, the method comprising:
configuring a terminal device to perform and report channel measurements for a first reference signal resource set and interference measurements for a second reference signal resource set;
transmitting the first reference signal resource set and the second reference signal resource set; and
receiving reporting of the channel measurements and the interference measurements, from the terminal device, wherein the interference measurements are reported as a function of measurement on at least two reference signal resources in the second reference signal resource set.

2. The method of claim 1, wherein the channel measurements and the interference measurements are reported as a combined link quality metric.

3. The method of claim 1, wherein the network node configures the terminal device to report the interference measurements as a function of measurements on at least two reference signal resources in the second reference signal resource set.

4. The method of claim 1, wherein
the reporting indicates how the interference differs among different reference signal resources in the second reference signal resource set,
the terminal device is configured by the network node to receive the first reference signal resource set and the second reference signal resource set using one and the same spatial receiver filter as during reception of data and/or control signalling, and
the first reference signal resource set is transmitted in a first set of beams, where each reference signal resource in the first reference signal resource set is transmitted in its own beam in the first set of beams.

5. (canceled)

6. (canceled)

7. (canceled)

8. (canceled)

9. The method of claim 1, wherein
the second reference signal resource set is transmitted in a second set of beams, where each reference signal resource in the second reference signal resource set is transmitted in its own beam in the second set of beams,
the method further comprises estimating, based on the reporting of the interference measurements, interference level for the terminal device if any beam in the second set of beams is used for data and/or control signalling to another terminal device, and
the method further comprises receiving confirmation from the terminal device that the terminal device is capable of performing measurements and reporting the measurements as configured by the network node.

10. (canceled)

11. (canceled)

12. The method of claim 1, wherein
each of the channel measurements and the interference measurements are represented by, or accompanied by, CRI and RSRP values determined for the first reference signal resource set and the second reference signal resource set, and
for which of the first reference signal resource set and the second reference signal resource set the terminal device is to report channel measurements and for which of the first reference signal resource set and the second reference signal resource set the terminal device is to report interference measurements is based on reporting received from the terminal device of a beam sweep performed by the network node.

13. (canceled)

14. A method for channel measurement and interference measurement reporting, the method being performed by a terminal device, the method comprising:
receiving configuration from a network node to perform and report channel measurements for a first reference signal resource set and interference measurements for a second reference signal resource set;
receiving the first reference signal resource set and the second reference signal resource set whilst performing channel measurements on the first reference signal resource set and performing interference measurements on the second reference signal resource set; and
providing reporting of the channel measurements and the interference measurements to the network node, wherein the interference measurements are reported as a function of measurements on at least two reference signal resources in the second reference signal resource set.

15. The method of claim 14, wherein the channel measurements and the interference measurements are reported as a combined link quality metric.

16. The method of claim 14, wherein the terminal device is configured by the network node to report the interference measurements as a function of measurements on at least two reference signal resources in the second reference signal resource set.

17. The method of claim 14, wherein the reported interference measurements are determined as a linear average in power of measurements on the at least two reference signal resources in the second reference signal resource set.

18. The method of claim 14, wherein the interference measurements are reported as a function of measurements on all reference signal resources in the second reference signal resource set.

19. The method of claim 14, wherein
the reporting indicates how the interference differs among different reference signal resources in the second reference signal resource set, and
how the interference differs among different reference signal resources in the second reference signal resource set is indicated by the reporting comprising: i) a variance value of the interference measurements, ii) a value of highest interference measurement for the second reference signal resource set, iii) a flag that is set only when a variance value of the interference measurements is above a predetermined threshold level, or iv) a difference value determined as difference between highest measured interference for the second reference signal resource set and lowest measured interference for the second reference signal resource set.

20. (canceled)

21. (canceled)

22. (canceled)

23. (canceled)

24. The method of claim 14, wherein
the terminal device is configured by the network node to receive the first reference signal resource set and the second reference signal resource set using one and the same spatial receiver filter as during reception of data and/or control signalling,
each of the channel measurements and the interference measurements are represented by, or accompanied by, CRI and RSRP values determined for the first reference signal resource set and the second reference signal resource set,
one channel measurement for the first reference signal resource set is determined per receiver chain in the terminal device, and
one interference measurement for the second reference signal resource set is, per each receiver chain in the terminal device, reported as a function of measurements, per receiver chain, on at least two reference signal resources in the second reference signal resource set.

25. (canceled)

26. (canceled)

27. (canceled)

28. The method of claim 14, further comprising:
determining beam weights based on the channel measurements and the interference measurements, wherein
one set of the beam weights is determined for each receiver chain in the terminal device, and
the channel measurements and the interference measurements are reported as if the beam weights were applied when the first reference signal resource set and the second reference signal resource set were received.

29. (canceled)

30. (canceled)

31. The method of claim 14, further comprising:
providing confirmation to the network node that the terminal device is capable of performing measurements and reporting the measurements as configured by the network node.

32. The method of claim 1, wherein
the reporting of the channel measurements and the interference measurements defines a transmission hypothesis indication, and
each reference signal in the first reference signal resource set and in the second reference signal resource set is a non-zero power reference signal.

33. (canceled)

34. A network node for channel measurement and interference measurement acquisition, the network node comprising processing circuitry, the processing circuitry being configured to cause the network node to:
configure a terminal device to perform and report channel measurements for a first reference signal resource set and interference measurements for a second reference signal resource set;
transmit the first reference signal resource set and the second reference signal resource set; and
receive reporting of the channel measurements and the interference measurements, from the terminal device, wherein the interference measurements are reported as a function of measurement on at least two reference signal resources in the second reference signal resource set.

35. (canceled)

36. (canceled)

37. A terminal device for channel measurement and interference measurement reporting, the terminal device comprising processing circuitry, the processing circuitry being configured to cause the terminal device to:
receive configuration from a network node to perform and report channel measurements for a first reference signal resource set and interference measurements for a second reference signal resource set;
receive the first reference signal resource set and the second reference signal resource set whilst performing channel measurements on the first reference signal resource set and performing interference measurements on the second reference signal resource set; and
provide reporting of the channel measurements and the interference measurements to the network node, wherein the interference measurements are reported as a function of measurements on at least two reference signal resources in the second reference signal resource set.

38. (canceled)

39. (canceled)

40. A non-transitory computer readable storage medium storing computer code which, when run on processing circuitry of a network node, causes the network node to perform the method of claim 1.

41. A non-transitory computer readable storage medium storing computer code which, when run on processing circuitry of a terminal device, causes the terminal device to perform the method of claim 14.

42. (canceled)
